(19) United States
(12) Patent Application Publication
(10) Pub. No.: US 2020/0277790 A1
(43) Pub. Date: Sep. 3, 2020

(54) Roofing Membrane with Nonwoven Backing

(71) Applicant: Milliken & Company, Spartanburg, SC (US)

(72) Inventor: David E. Wenstrup, Greer, SC (US)

(21) Appl. No.: 16/793,580

(22) Filed: Feb. 18, 2020

Related U.S. Application Data
(60) Provisional application No. 62/811,852, filed on Feb. 28, 2019.

(51) Int. Cl. E04D 5/14; D04H 3/011; D04H 11/00; B32B 7/12; B32B 27/06; D04H 3/14; B32B 5/02; B32B 7/08; B32B 27/32; B32B 27/30

(52) U.S. Cl. CPC E04D 5/14; D04H 3/011; D04H 11/00; B32B 7/12; B32B 27/06; D04H 3/14; B32B 2305/20; B32B 7/08; B32B 27/32; B32B 27/304; B32B 2260/04; B32B 2419/06; B32B 2262/0276; B32B 5/022

(57) ABSTRACT

A roofing membrane having a first and a second side and comprises a membrane layer and a nonwoven layer. The membrane layer forms the second side of the membrane and the nonwoven layer forms the first side of the membrane. The nonwoven layer has a weight of between about 2.5 and 15.5 ounces per square yard and comprises a plurality of intertangled fibers. At least 60% by number of the intertangled fibers have a length of at least about 3 inches and the intertangled fibers have a round or tri-lobal shape. The intertangled fibers comprise a mixture of a bulking fiber and a core/shell low melt fiber, where the shell of the low melt fiber has a melting temperature between about 50 and 220° C. and the bulking fibers have a melting temperature of at least about of 240° C. The first side of the membrane has a plurality of loop elements.

### RELATED APPLICATIONS

This application claims priority to co-pending U.S. Provisional Application 62/811,852, filed on Feb. 28, 2019, which is herein incorporated by reference in its entirety.

### TECHNICAL FIELD

The present disclosure relates generally to roofing membranes containing a nonwoven fleece backing with one side of said nonwoven fleece containing a side where the fibers on that side are lengthened and exposed between entanglement points.

### BACKGROUND

Membranes, such as membranes used in roofing, sometimes contain a fabric layer embedded into one side of the membrane. Typically, this fabric layer is incorporated to allow the membrane to be fully adhered to the roof deck using an adhesive. Additionally, this fleece can enable the membrane to adhere to rough surface decks, or even decks with small hooks incorporated into said deck.

### BRIEF SUMMARY

A roofing membrane is described having a first and a second side and comprises a membrane layer and a nonwoven layer. The membrane layer forms the second side of the membrane and the nonwoven layer forms the first side of the membrane. The nonwoven layer has a weight of between about 2.5 and 15.5 ounces per square yard and comprises a plurality of intertangled fibers. At least 60% by number of the intertangled fibers have a length of at least about 3 inches and the intertangled fibers have a round or tri-lobal shape. The intertangled fibers may contain a mixture of a bulking fiber and a core/shell low melt fiber, where the shell of the low melt fiber has a melting temperature between about 50 and 220° C. and the bulking fibers have a melting temperature of at least about of 240° C.

A nonwoven fleece of entangled fibers contains sections of fiber between entanglement points that can catch on a rough surface or hook. Often a calendar or coating is used to reduce the exposure of these sections to increase the ability of the membrane to be moved prior to adhesion. In this invention, an opposite approach is taken and the section between entanglement points are both lengthened and exposed (‘enhanced section’) to increase adhesion.

### BRIEF DESCRIPTION OF THE DRAWING(S)

Exemplary embodiments will now be described by way of example, with reference to the accompanying drawings, wherein:

FIG. 1 is a cross-sectional illustration of one embodiment of the membrane.

FIG. 2 is an illustration of one embodiment of a roofing system.

### DETAILED DESCRIPTION

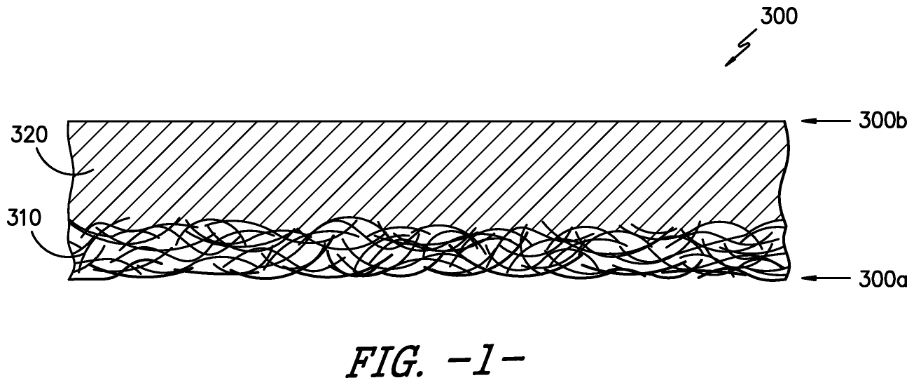

FIG. 1 illustrates one embodiment of the roofing membrane 300. The roofing membrane 300 has a first side 300a and a second side 300b and comprises a membrane layer 320 and a nonwoven layer 310. The nonwoven layer forms the first side 300a of the membrane 300 and the membrane layer 320 forms the second side 300b of the membrane 300. The first side 300a of the membrane 300 has ‘enhanced sections’ of fibers on side 300a. These ‘enhanced sections’ can be used in combination with purposely roughed surfaces or hook elements attached to the roof decking to increase adhesion of roofing membrane 300 to the roof decking.

The membrane is any suitable membrane, preferably designed to withstand the elements for use in an outdoor roofing application. In one embodiment, the membrane layer 320 comprises polyvinyl chloride (PVC). In another embodiment, the membrane layer 320 comprises Ethylene Propylene Diene Monomer (EPDM) rubber. In another embodiment, the membrane layer 320 comprises TPO (thermoplastic olefin). The membrane layer typically has a thickness of between about 30 and 100 mils (thousandths of an inch), more preferably between about 45 and 85 mils. It has been found that these ranges produce a membrane layer 320 that is flexible yet very tough and durable.

In one embodiment, the membrane layer 320 may contain a scrim. The scrim preferably comprises a plurality of warp yarns in a first direction and a plurality of weft yarns in a second direction approximately perpendicular to the first direction. The scrim may be any suitable scrim layer including any suitable light-weight woven, knit, or nonwoven fabric. Preferably, the scrim is a weft inserted warp knit scrim. The scrim is preferably open meaning that there are large amounts of open space between the yarns within the scrim. This is preferred so that there can be good adhesion of the polymer of the membrane layer through the scrim, when the scrim is incorporated into the center of the membrane.

The yarns used in the scrim may be any suitable yarn, including but not limited to a spun staple yarn, a multifilament yarn, and/or a monofilament yarn. “Yarn”, in this application, as used herein includes a monofilament elongated body, a multifilament elongated body, ribbon, strip, fiber, tape, and the like. The term yarn includes a plurality of any one or combination of the above. Some suitable materials for the yarns include polyamide, aramids (including meta and para forms), rayon, PVA (polyvinyl alcohol), polyester, polyolefin, polyvinyl, nylon (including nylon 6, nylon 6, 6, and nylon 4,6), polyethylene naphthalate (PEN), cotton, steel, carbon, fiberglass, steel, polyacrylic or any other suitable artificial or natural fiber. In one embodiment, the yarns in the scrim layer 110 are preferably continuous multifilament polyester. Continuous multifilament polyester has been shown to have good adhesion and strength characteristics.

The nonwoven layer 310 may be any suitable nonwoven layer, preferably a needle punched nonwoven layer. The nonwoven layer 310 forms the first side 300a of the membrane. The parameters of the nonwoven 310 must be selected carefully to ensure good adhesion to both the membrane 300 and the roof decking.

The nonwoven layer has a weight of between about 2.5 and 15.5 ounces per square yard, more preferably between about 4.5 and 9.5 ounces per square yard. The nonwoven layer comprises a plurality of intertangled fibers. Optimally the nonwoven layer 310 is formed carding, cross-lapping, and needle-punching plurality of bulking fibers and binder fibers.

The bulking fibers of the nonwoven layer 310 are fibers that provide volume in the z-direction, which extends perpendicularly from the planar dimension of the membrane 300. Types of bulking fibers would include (but are not limited to) fibers with high denier per filament (3 denier per filament or larger), high crimp fibers, hollow-fill fibers, and the like. These fibers provide mass and volume to the material. Some examples of bulking fibers include polyester and polypropylene as well as other low-cost fibers. Preferably, the bulking fibers have a denier greater than about 3 denier. In another embodiment, the bulking fibers have a denier greater than about 6 denier. The bulking fibers are preferably staple fibers. The staple length of the fibers is preferably large enough to allow creation of an ‘enhanced section’ on the first side 300a of the nonwoven 310 without being pulled out. Preferably, at least 60% by number of the fibers (all fibers in the nonwoven, not just the bulking fibers) have a staple length of at least about 2 inches, more preferably at least about 3 inches.

The bulking fibers can have any suitable cross-sectional shape including but not limited tom circular, oval, square, rectangular, segmented pie, 4DG, winged fibers, and tri-lobal. Preferably, the intermingled fibers have a round cross-sectional shape. In another embodiment, the intermingles fibers preferably have a tri-lobal cross-sectional shape. Preferably, the bulking fibers have a melting temperature of at least 220° C., more preferably at least 240° C., more preferably at least about 250° C.

In a preferred embodiment, the bulking fibers comprise polyester. Polyester fibers can be manufactured from post-consumer bottles and post-industrial wastes and are generally less expensive than polypropylene or nylon staple fibers.

In one embodiment, the nonwoven layer 310 contains binder fibers. The binder fibers preferably are fibers that form an adhesion or bond with the other fibers, which includes fibers that are heat activated. Examples of heat activated binder fibers are fibers that can melt at lower temperatures, such as low melt fibers, bi-component fibers, such as side-by-side or core and shell fibers with a lower sheath melting temperature, and the like. In one preferred embodiment, the binder fibers are core/shell fiber having a polyester core and polyester shell having a lower melt temperature than the core. Preferably, when the membrane 300 is formed, the binder fibers remain as discernable fibers and the intertangles fibers of the nonwoven layer are adhered together at their cross-over points. In another embodiment, in the finished membrane 300, the binder fibers lose their fiber shape and form a coating on surrounding materials. Preferably, the binder fibers have a denier less than or about equal to 15 denier, more preferably less than about 6 denier. Preferably, the shells of the binder fibers have a melting temperature of between about 50 and 220° C., more preferably at least less than 180° C. In one embodiment, the melting temperature of the shell of the binder fibers is least about 30° C. less than the melting temperature of the bulking fibers.

In one embodiment, the nonwoven layer 310 consists essentially of polyester fibers. “Consists essentially” in this application is defined to mean at least 95% by weight of the fibers is polyester. This enables the nonwoven to be more easily processed and recycled.

In one embodiment, the first nonwoven layer undergoes a second needle-punching step to produce loops creating an ‘enhanced section’. The first nonwoven layer is passed over a brush having a series of projections and interstices between the projections. The first nonwoven 320 is then needled from the top surface of nonwoven 310 into the brush apparatus such that a portion of the primary fibers are pushed into the interstices of the brush apparatus and out of and away from the surface. This creates a loop-like surface on the first surface 300a of the nonwoven 310. Some also refer to this process as a velour process.

The membrane layer 320 may be formed independently and then be attached to the nonwoven layer 310, or it can be formed on the nonwoven layer in a manner such as coating or extruding. If the membrane layer 320 is formed as a free standing film, then the membrane layer 320 and the nonwoven layer 310 can be attached by any suitable means such as a pressure sensitive adhesive, a low melt adhesive, using heat and/or pressure with no additional adhesive (using a portion of the fibers in the nonwoven layer 310 and/or the polymer of the membrane layer 320 to at least partially melt and adhere the two layers together). In one preferred embodiment, there is an adhesive located between the membrane layer 320 and the nonwoven layer 310. In another embodiment, the membrane layer 320 and the nonwoven layer 310 are adjacent to and in contact with each other (with no additional adhesives between the two layers).

The membrane layer 320 and the membrane 300 may be subjected to additional processing steps such as coatings, surface treatments, adhering the membrane to additional components, and calendaring.

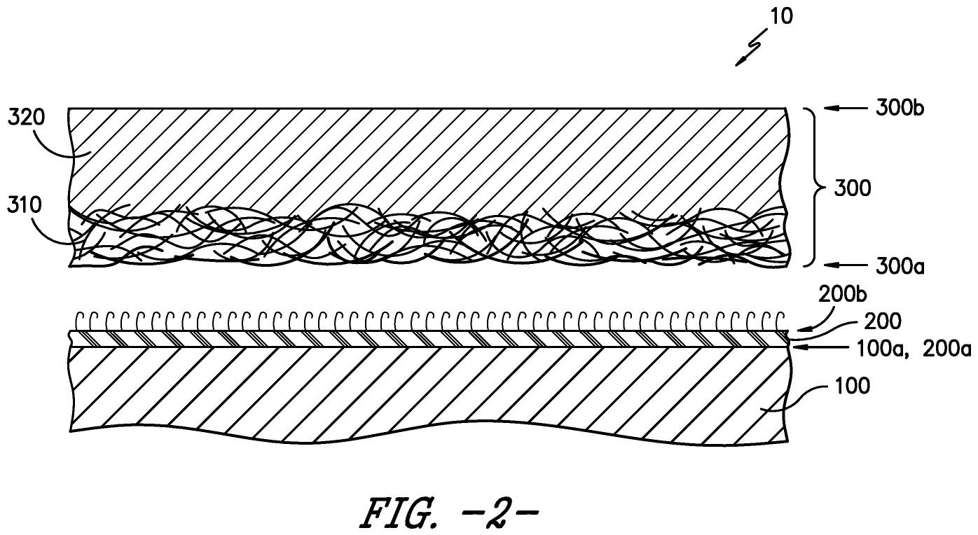

The membrane 300 may be used in a roofing application such as shown in FIG. 2. The roofing system 10 contains a roof deck 100 which has an upper surface 100a. The roof deck is considered to be the upper most surface of the roof before the membrane is applied and can be wood, metal, foam, or any other suitable material. A hook fastening layer 200 is attached to the roof deck 100. The hook fastening system has a first side 200a which faces the roof deck 100 and a second side 200b which faces away from the roof deck 100. The second side 200b of the hook fastening layer 200 has a series of hooks. The hooks are in a height, density, and shape to be able to releasable engage with the loops from the membrane 300. How much or little the hooks and loops engage is determined by both the structure of the hooks and the loops. For roofing applications, it would be desirable to have a strong engagement to hold the membrane 300 down well on the roof and prevent lift off due to wind or other weather conditions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A roofing membrane having a first side and a second side and comprising:
a membrane layer, wherein the membrane layer forms the second side of the membrane; and,
a nonwoven layer, wherein the nonwoven layer forms the first side of the membrane, wherein the nonwoven layer has a weight of between about 2.5 and 15.5 ounces per square yard, wherein the nonwoven layer comprises a plurality of intertangled fibers, wherein at least 60% by number of the intertangled fibers have a length of at least about 3 inches, wherein the intertangled fibers have a round or tri-lobal shape, and wherein the first side of the membrane has a plurality of loop elements.

2. The roofing membrane of claim 1, wherein the bulking fibers have a melting temperature of at least about of 240° C.

3. The roofing membrane of claim 1, wherein the nonwoven layer has a weight of between about 4.5 and 9.5 ounces per square yard.

4. The roofing membrane of claim 1, wherein the nonwoven layer comprises essentially all polyester fibers.

5. The roofing membrane of claim 1, wherein the intertangled fibers of the nonwoven layer cross over each other at cross-over points.

6. The roofing membrane of claim 5, wherein the intertangled fibers are adhered together at the cross-over points.

7. The roofing membrane of claim 1, wherein the intertangled fibers have a round shape.

8. The roofing membrane of claim 1, wherein the intertangled fibers have a tri-lobal shape.

9. The roofing membrane of claim 1, wherein the nonwoven layer is subjected to a velouring process.

10. The roofing membrane of claim 1, wherein the roof further comprises an adhesive located between the roof deck and the hook fastening layer.

11. The roofing membrane of claim 1, wherein the membrane layer comprises a scrim.

12. The roofing membrane of claim 11, wherein the scrim is embedded into the membrane layer.

13. The roofing membrane of claim 11, wherein the scrim is a weft insert warp knit fabric.

14. The roofing membrane of claim 1, wherein the membrane layer comprises polyvinyl chloride.

15. The roofing membrane of claim 1, wherein the membrane layer comprises thermoplastic olefin.

16. The roofing membrane of claim 1, wherein the membrane further comprises an adhesive located between the membrane layer and the nonwoven layer.

17. The roofing membrane of claim 1, wherein at least a portion of the intertangles fibers from the nonwoven layer that form the first side of the membrane are at least partially melted.

18. The roofing membrane of claim 1, wherein the nonwoven is a velour.

19. The roofing membrane of claim 1, wherein the membrane layer of the membrane has a thickness of between about 30 and 100 thousandths of an inch (mils).

20. The roofing membrane of claim 1, wherein the intertangled fibers comprise a mixture of a bulking fiber and a core/shell low melt fiber, wherein the shell of the low melt fiber has a melting temperature between about 50 and 220° C. and the bulking fibers have a melting temperature of at least about of 240° C.
